(19) United States
(12) Patent Application Publication
(10) Pub. No.: US 2011/0139946 A1
(43) Pub. Date: Jun. 16, 2011

(54) Universal Flip Stand for portable hand-held devices

(76) Inventor: Mike Gonzalez, Pearland, TX (US)

(21) Appl. No.: 12/860,892

(22) Filed: Aug. 22, 2010

Related U.S. Application Data
(60) Provisional application No. 61/274,868, filed on Aug. 21, 2009.

(51) Int. Cl. F16B 47/00; F16M 11/04

(52) U.S. Cl. 248/121; 248/206.2

(57) ABSTRACT

The stand has an adjustable arm that will allow users to hang the accessory over any headrest. The arm can be adjusted along a hinge to change the length for varying widths of headrest. The arm can also rotate to be angled for placement on a flat surface such as a table. The device can be placed in the stand vertically or horizontally. A suction cup accessory for the device can slip over the arms to allow it to be mounted to an automobile windshield.

The universal flip stand has numerous locations that it can be used. The adjustable angle arm allows the invention to stand alone on desk/table/airplane tray or other flat surfaces. The arm can be extended to support hanging the invention between a headrest and back of a driver/passenger seat of many vehicles. A slip on suction cup accessory over the arms of the invention will also allow positioning on glass surfaces such a front windshield for gps navigation devices. Similar devices are limited to specific products or even specific models manufactured and can not be applied for use with multiple products or more than one intended use.

### BRIEF DESCRIPTION OF DRAWINGS

FIG. 1 is a front view of the stand with arms fully extended behind the stand and the opening for devices fully open.

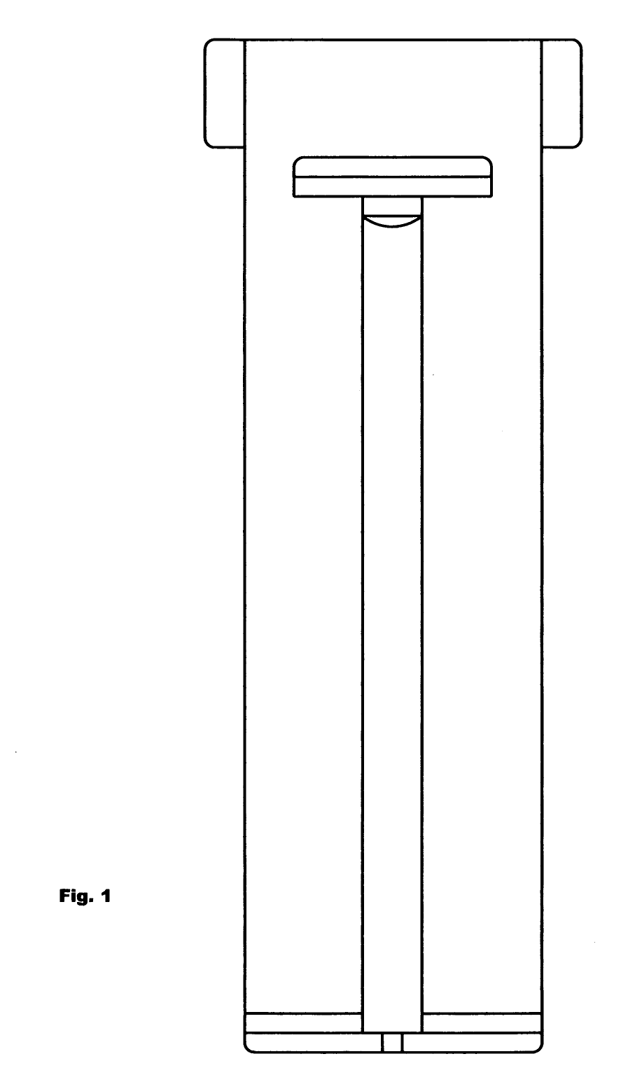

FIG. 2 is a front view with hidden parts of the stand identified.

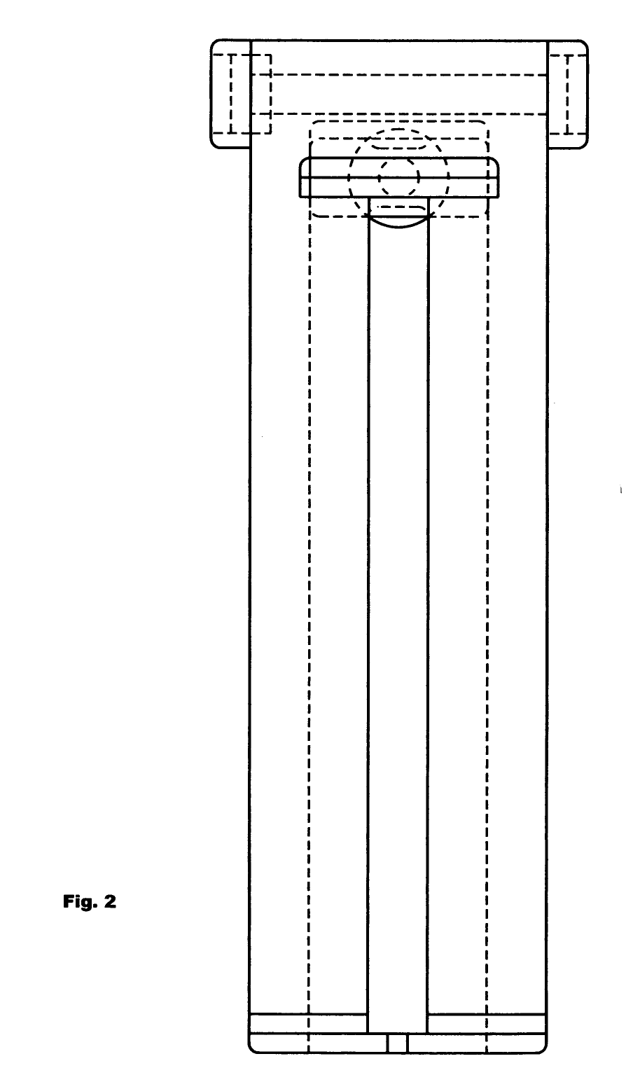

FIG. 3 is a back view of the stand with the arms fully extended and not visible. Back of the stand is the exposed knob to tighten and loosen the adjustable brace for multiple products.

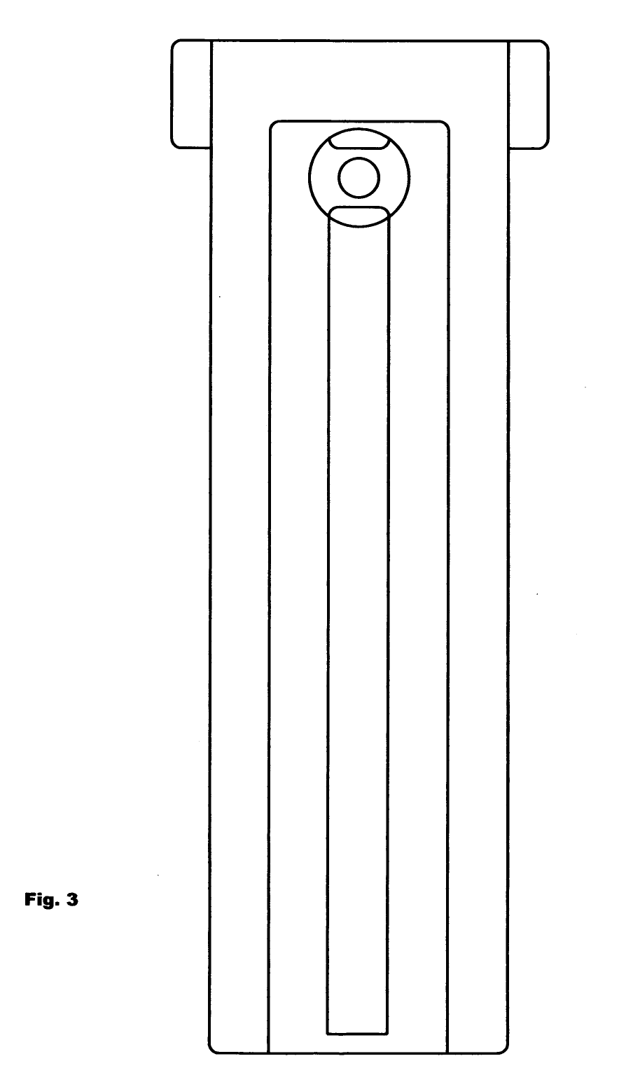

FIG. 4 is a back view with hidden parts of the stand identified.

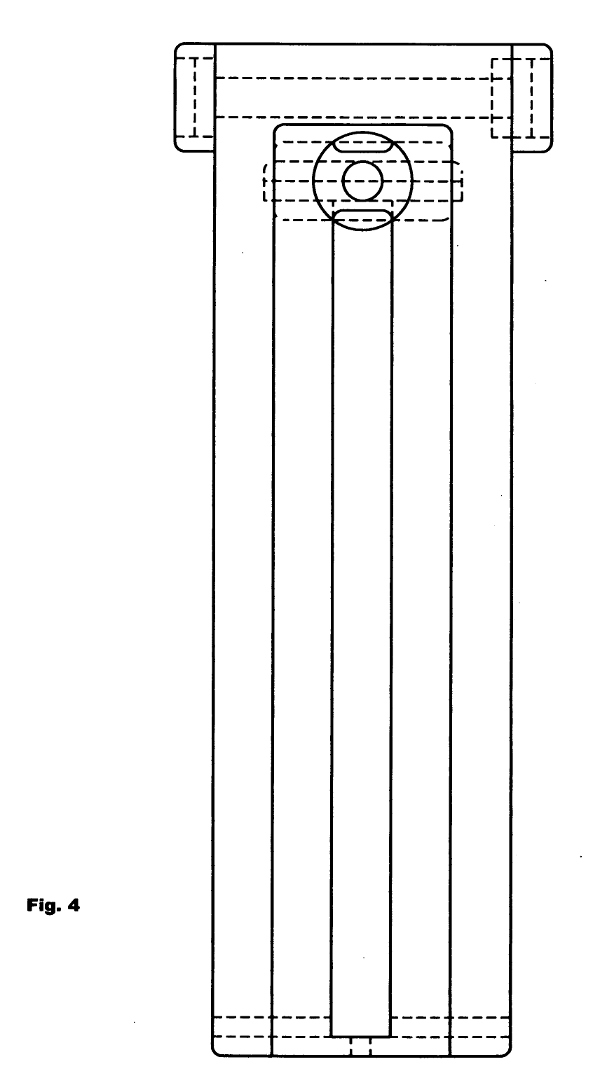

FIG. 5 is a view of the left side of the stand with the arms fully extended behind the stand, opening for devices fully open, and drop down flap on arms extended down.

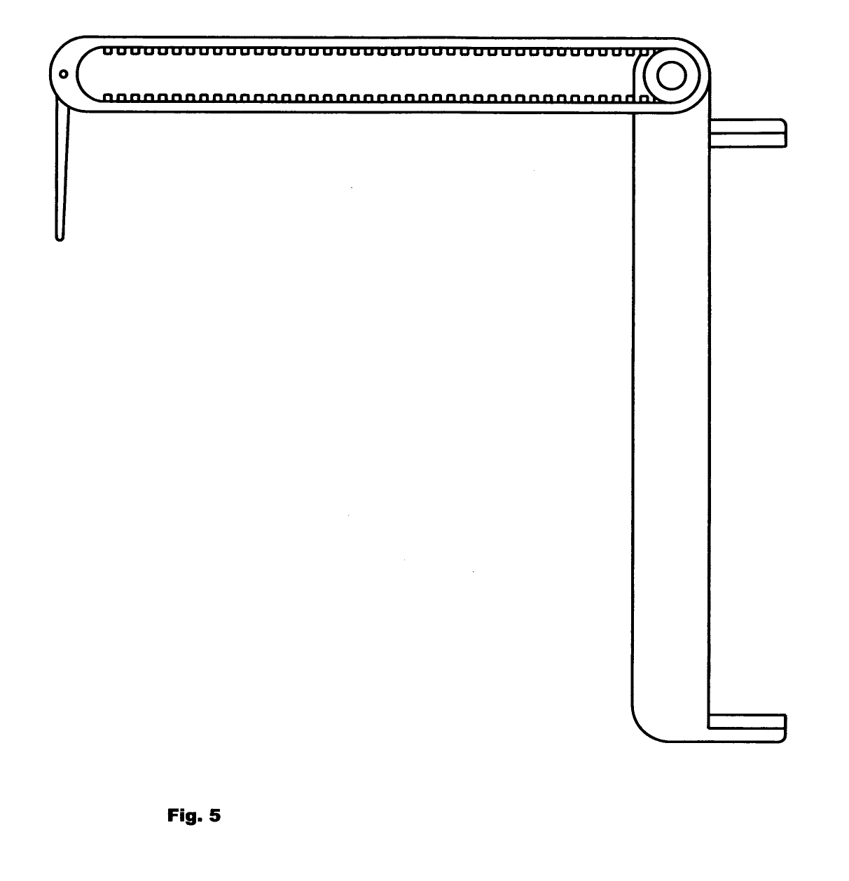

FIG. 6 is the left view with hidden parts of the stand identified.

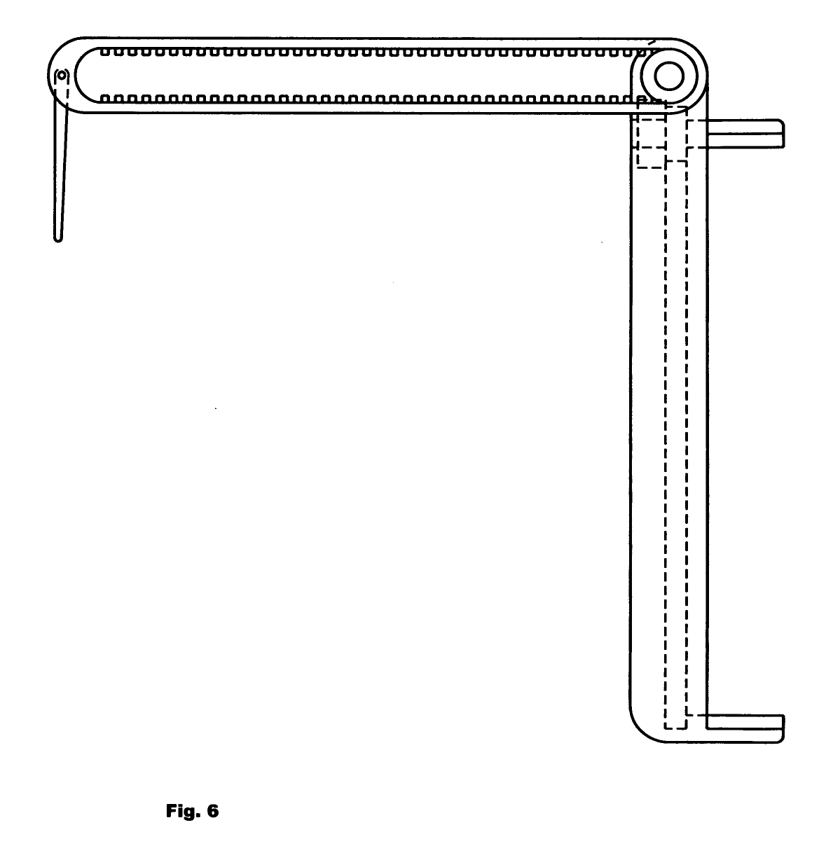

FIG. 7 is a view of the right side of the stand with the arms fully extended behind the stand, opening for devices fully open, and drop down flap on arms extended down.

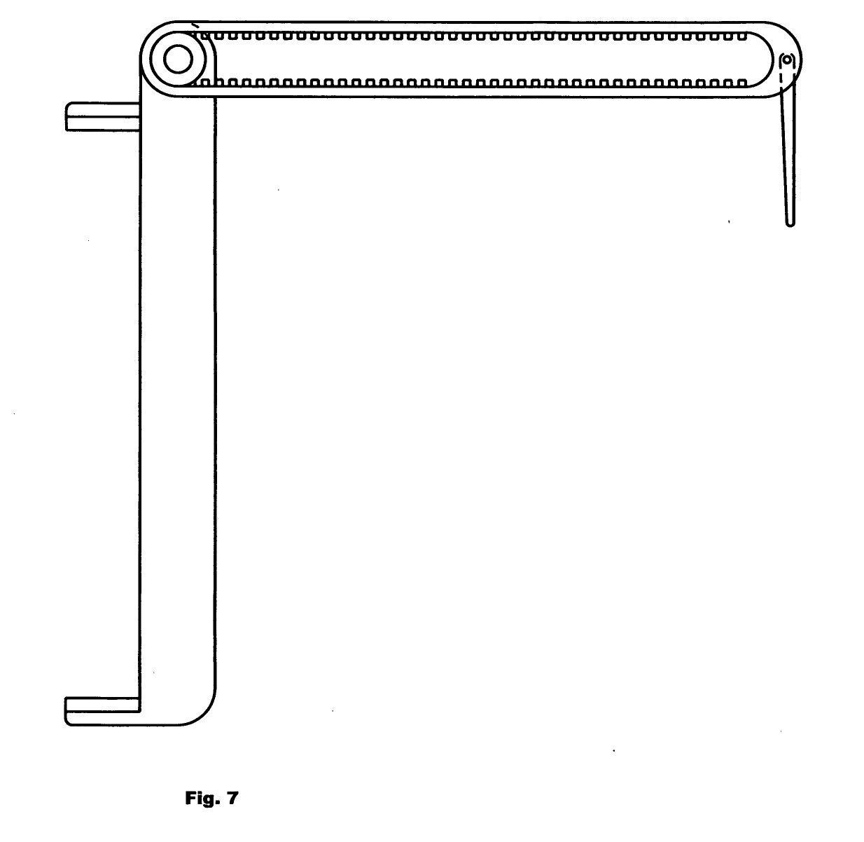

FIG. 8 is a view of the right side with the slip on band over the arms and drop down flap on arms folded in. The suction cup on the band is also visible.

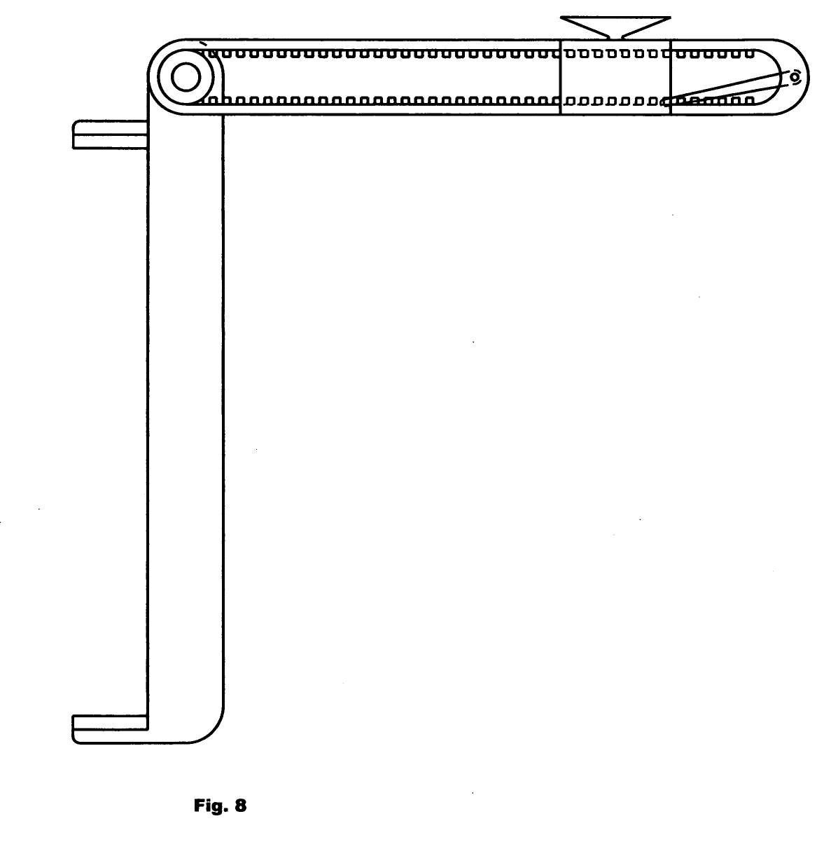

FIG. 9 is a top view of the stand with the arms fully extended behind the stand and drop down flap on arms extended down.

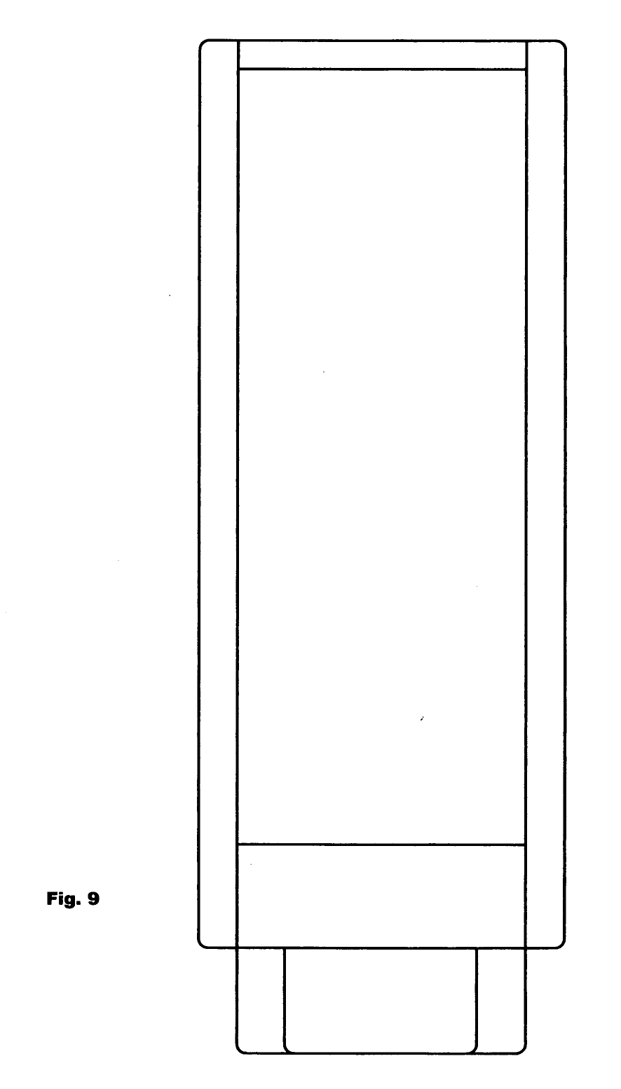

FIG. 10 is the top view with hidden parts of the stand identified.

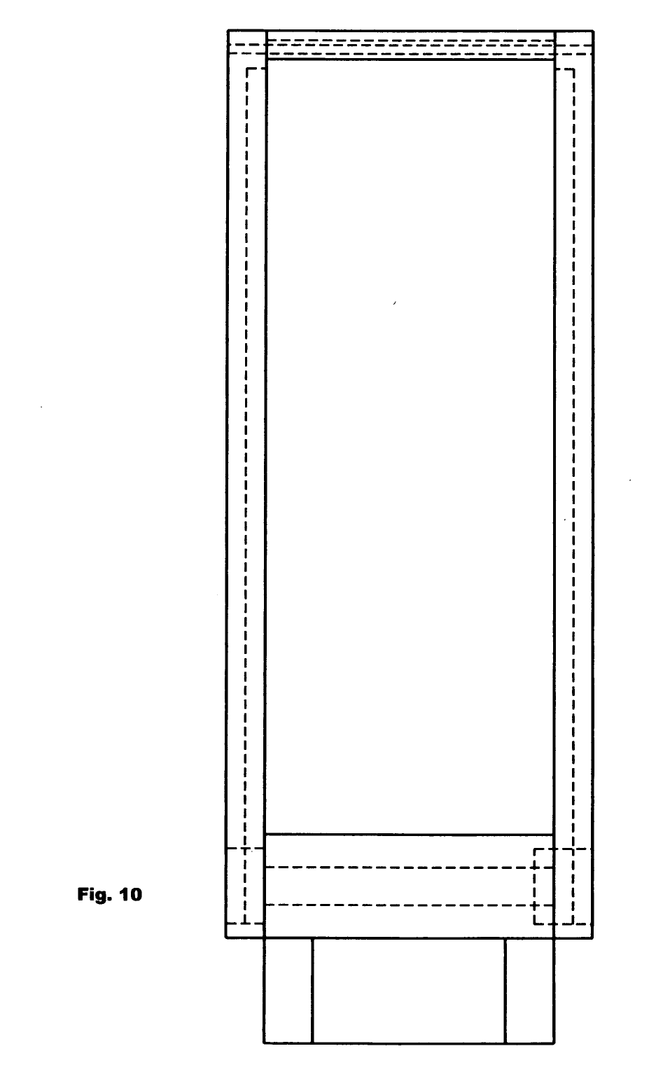

FIG. 11 is the top view with hidden parts of the stand identified and slip on band with suction cup over the arms.

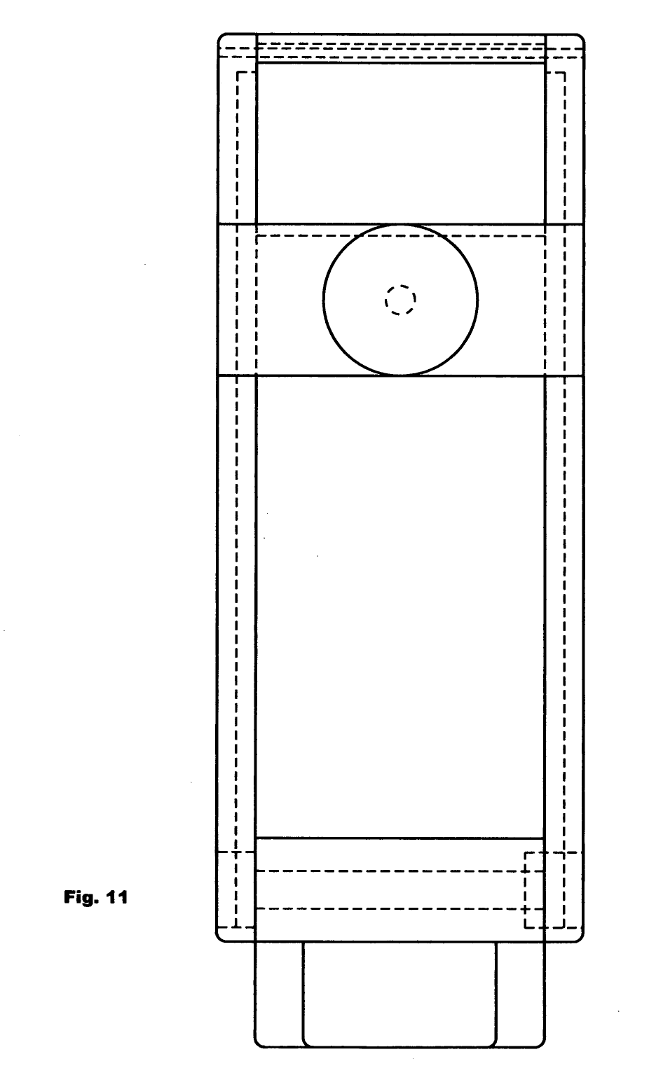

FIG. 12 is a front view of the stand with the arms folded in front of the stand, opening for devices fully closed, and drop down flap folded in.

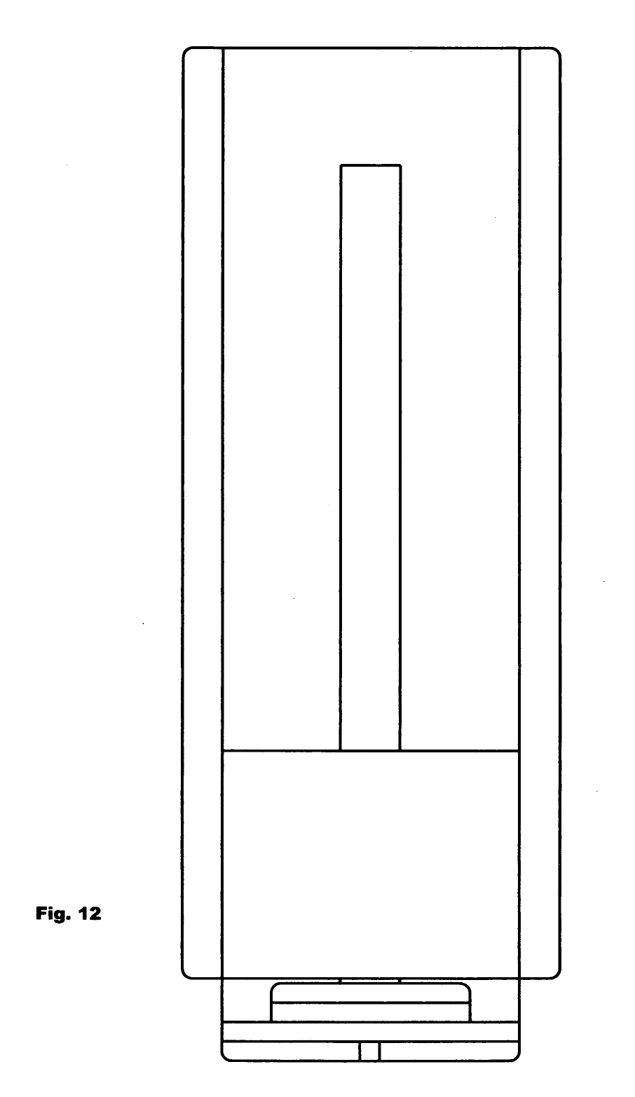

FIG. 13 is a folded front view with hidden parts identified.

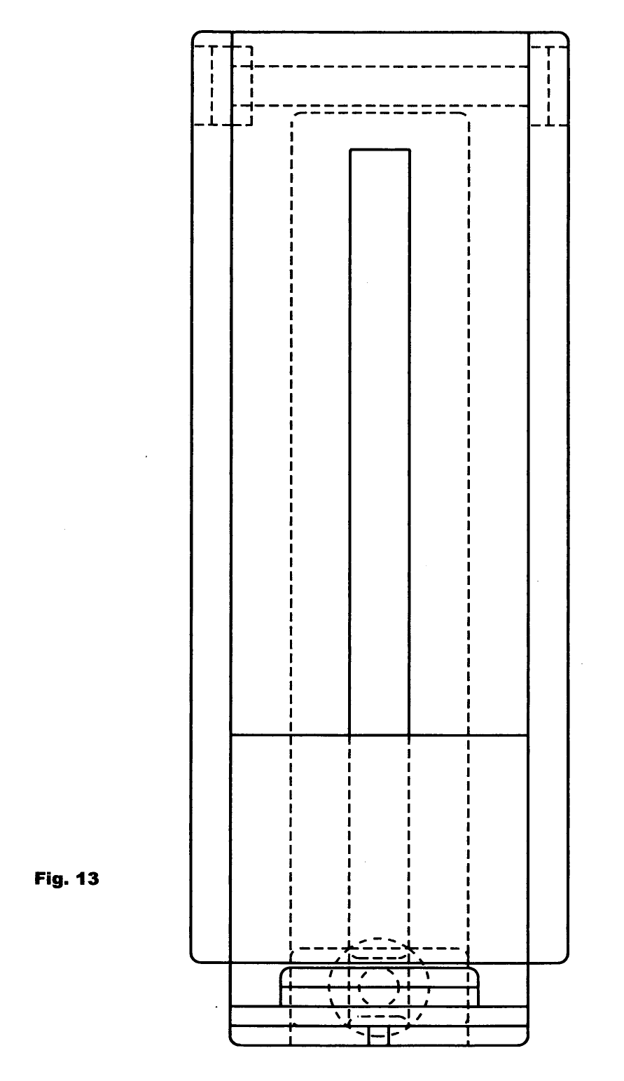

The invention claimed is:

1. A portable, adjustable, glass mountable (with the aid of slip on suction cup accessory) device apparatus with multiple applications for use with numerous device types not limited to such products but includes: mobile cellular phones, personal digital media storage devices (mp3 players, video players), portable gaming devices, portable GPS navigation systems, small notebooks, pocket televisions, and other handheld devices.

2. The device in claim 1, comprises of adjustable front mounts for use with products of different heights/widths for appropriate positioning and support.

3. The device in claim 1, also comprises of 2 adjustable synchronized arms to accommodate standing, angled viewing, or mounting on other free standing objects.

4. The adjustable synchronized arms in claim 3, also has a drop down flap to support hanging of invention.

5. The device in claim 1, also has a slip on and off sleeve with a suction cup to stick to glass or other similarly flat surfaces.
